(19) United States
(12) Patent Application Publication
(10) Pub. No.: US 2021/0102100 A1
(43) Pub. Date: Apr. 8, 2021

(54) Adhesive Compositions Including Polyvinyl Acetal Resin And Articles Containing The Same

(71) Applicant: 3M INNOVATIVE PROPERTIES COMPANY, St. Paul, MN (US)

(72) Inventors: Ying Xia, Woodbury, MN (US); Tien Yi T. H. Whiting, St. Paul, MN (US); Carla S. THOMAS, St. Paul, MN (US); Anthony F. Schultz, Forest Lake, MN (US); Shri Niwas, Maple Grove, MN (US); Duane D. Fansler, Dresser, WI (US); Daniel J. O'Neal, St. Paul, MN (US); Corinne E. LIPSCOMB, Saint Paul, MN (US); Mary M. Caruso Dailey, Maplewood, MN (US); Alexander J. Kugel, Woodbury, MN (US)

(21) Appl. No.: 16/618,837

(22) PCT Filed: Jun. 19, 2018
(86) PCT No.: PCT/US2018/038160

§ 371 Date: Dec. 3, 2019

Related U.S. Application Data
(60) Provisional application No. 62/522,279, filed on Jun. 20, 2017.

(51) Int. Cl. C09J 151/00; B32B 5/16; B32B 7/12; B32B 5/02; B32B 5/24; B32B 5/30

(52) U.S. Cl. CPC C09J 151/003; B32B 5/16; B32B 7/12; B32B 5/024; B32B 5/24; B32B 5/022; B32B 2307/546; B32B 2255/20; B32B 2262/0276; B32B 2262/062; B32B 2437/00; B32B 2307/416; B32B 5/30

(57) ABSTRACT

Adhesive compositions that include polymerized units of one or more (meth)acrylate ester monomers derived from an alcohol containing 1 to 14 carbon atoms; polyvinyl acetal resin; and at least one initiator; and articles containing such compositions.

### SUMMARY

Disclosed herein are adhesive compositions that include polymerized units of one or more (meth)acrylate ester monomers derived from an alcohol containing 1 to 14 carbon atoms; polyvinyl acetal resin; and at least one initiator.

Also disclosed are articles that include at least one application layer; at least one bead bond layer; a layer of optical elements that are partially embedded in the at least one bead bond layer; and at least one reflective layer that is located functionally between the layer of optical elements and the bead bond layer, wherein the at least one bead bond layer, the at least one application layer, or both comprise a cured product of a disclosed adhesive composition.

The above summary of the present disclosure is not intended to describe each disclosed embodiment or every implementation of the present disclosure. The description that follows more particularly exemplifies illustrative embodiments. In several places throughout the application, guidance is provided through lists of examples; examples can be used in various combinations. In each instance, the recited list serves only as a representative group and should not be interpreted as an exclusive list.

### BRIEF DESCRIPTION OF THE DRAWINGS

FIG. 1 shows a cross-sectional view of an embodiment of an intermediate article of this disclosure.

FIG. 2 shows a cross-sectional view of an embodiment of an intermediate article of this disclosure.

FIG. 3 shows a cross-sectional view of an embodiment of an article of this disclosure.

FIG. 4 shows a cross-sectional view of an embodiment of an article of this disclosure.

FIG. 5 shows a top view of an embodiment of an article of this disclosure

FIG. 6 is a schematic depiction of an article.

FIG. 7 shows a schematic depiction of how articles of FIG. 6 can be fabricated.

FIG. 8 shows a schematic depiction of another method of fabricating articles of FIG. 6.

FIGS. 9a and 9b show schematic depictions of another method of fabricating articles of FIG. 6.

FIG. 10 shows a schematic depiction of another method of fabricating articles of FIG. 6.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Disclosed compositions can function as adhesive compositions. The term “adhesive” can refer to polymeric compositions useful to adhere together to adherends. Examples of types of adhesives are pressure sensitive adhesives, heat activated adhesives and laminating adhesives.

Pressure sensitive adhesive compositions are well known to those of ordinary skill in the art to possess properties including the following: (1) aggressive and permanent tack at room temperature, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

Heat activated adhesives are non-tacky at room temperature but become tacky and capable of bonding to a substrate at elevated temperatures. These adhesives usually have a glass transition temperature (Tg) or melting point (Tm) above room temperature. When the temperature is elevated above the Tg or Tm, the storage modulus usually decreases and the adhesive become tacky.

Laminating adhesives (also sometimes referred to as contact adhesives) are adhesives designed to form bonds to two substrates immediately after dispensing. Once the adhesive has been dispensed, there is a limited time, sometimes referred to as “open time” in which the adhesive can form a bond to two substrates. Once the open time has elapsed, the laminating adhesive is no longer capable of forming adhesive bonds. Examples of laminating adhesives are hot melt adhesives, solutions or dispersions of polymeric materials or materials curable to form polymeric materials in a liquid medium, and curable adhesives. The laminating adhesive is coated onto a substrate, a second substrate is contacted to the adhesive surface and the formed three layer construction is cooled, dried, and/or cured to form a laminate. Examples of laminating adhesives include the glue sticks used in hot glue guns (which are hot melt types of adhesives that form bonds upon cooling), casein glues, sometimes called “white glue”, (which are water-borne dispersions that form bonds upon drying), and cyanoacrylate adhesives (which cure to form bonds upon exposure to air).Unless otherwise indicated, the terms “transparent” and “optically transparent” are used interchangeably and refer to an article, film or adhesive that has a high light transmittance over at least a portion of the visible light spectrum (about 400 to about 700 nm).

Disclosed compositions include polymerized units of one or more (meth)acrylate ester monomers, polyvinyl acetal resin; and at least one initiator.

### (Meth)Acrylate Ester Monomers

Disclosed compositions include polymerized units of one or more (meth)acrylate ester monomers derived from a (e.g. non-tertiary) alcohol containing 1 to 14 carbon atoms and in some embodiments an average of 4 to 12 carbon atoms

Examples of monomers include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol; 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, and the like.

Compositions can also be described as including polymerized units of one or more low Tg (meth)acrylate monomers, e.g., a (meth)acrylate monomer when reacted to form a homopolymer has a Tg no greater than 0° C. In some embodiments, the low Tg monomer has a Tg no greater than −5° C., or no greater than −10° C. The Tg of these homopolymers is often greater than or equal to −80° C., greater than or equal to −70° C., greater than or equal to −60° C., or greater than or equal to −50° C.

The low Tg monomer may have the formula:

H₂C═CR¹C(O)OR⁸

where R¹ is H or methyl and R⁸ is an alkyl with 1 to 22 carbons or a heteroalkyl with 2 to 20 carbons and 1 to 6 heteroatoms selected from oxygen or sulfur. The alkyl or heteroalkyl group can be linear, branched, cyclic, or a combination thereof. The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

Exemplary low Tg monomers include for example ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, 2-octyl acrylate, isooctyl acrylate (having a glass transition temperature of about Tg=−70° C.), isononyl acrylate, decyl acrylate, isodecyl acrylate, lauryl acrylate, isotridecyl acrylate, octadecyl acrylate, and dodecyl acrylate.

Low Tg heteroalkyl acrylate monomers include, but are not limited to, 2-methoxyethyl acrylate and 2-ethoxyethyl acrylate.

In some embodiments, the film and composition comprises polymerized units of at least one low Tg monomer(s) having an alkyl group with 6 to 20 carbon atoms. In some embodiments, the low Tg monomer has an alkyl group with 7 or 8 carbon atoms. Exemplary monomers include, but are not limited to, 2-ethylhexyl (meth)acrylate, isooctyl (meth)acrylate, n-octyl (meth)acrylate, 2-octyl (meth)acrylate, isodecyl (meth)acrylate, and lauryl (meth)acrylate.

In some embodiments, the monomer is an ester of (meth)acrylic acid with an alcohol derived from a renewable source. A suitable technique for determining whether a material is derived from a renewable resource is through ¹⁴C analysis according to ASTM D6866-10, as described in US2012/0288692. The application of ASTM D6866-10 to derive a “bio-based content” is built on the same concepts as radiocarbon dating, but without use of the age equations. The analysis is performed by deriving a ratio of the amount of organic radiocarbon (¹⁴C) in an unknown sample to that of a modern reference standard. The ratio is reported as a percentage with the units “pMC” (percent modern carbon).

One suitable monomer derived from a renewable source is 2-octyl (meth)acrylate, as can be prepared by conventional techniques from 2-octanol and (meth)acryloyl derivatives such as esters, acids and acyl halides. The 2-octanol may be prepared by treatment of ricinoleic acid, derived from castor oil, (or ester or acyl halide thereof) with sodium hydroxide, followed by distillation from the co-product sebacic acid. Other (meth)acrylate ester monomers that can be renewable are those derived from ethanol and 2-methyl butanol. In some embodiments, the film and composition comprises a bio-based content of at least 10, 15, 20, 25, 30, 35, 40, 45, 50, 55 or 60 wt-% using ASTM D6866-10, method B.

Disclosed compositions typically comprise at least 10, 15, 20 or 25 wt-% of polymerized units of monofunctional alkyl (meth)acrylate monomer having a Tg of less than 0° C., based on the total weight of the polymerized units (i.e. excluding inorganic filler or other additives). The film and composition typically comprises no greater than 60, 55, 50, 45, or 40 wt-% of polymerized units of monofunctional alkyl (meth)acrylate monomer having a Tg of less than 0° C., based on the total weight of the polymerized units.

When disclosed compositions are free of unpolymerized components such an inorganic filler and additives, the wt-% of specified polymerized units is approximately the same as the wt-% of such polymerized units present in the total composition. However, when the composition comprises unpolymerized components, such as inorganic filler or other unpolymerizable additive the total composition can comprise substantially less polymerized units. In general, the total amount of unpolymerizable additives may range up to 25 wt-%. Thus, in the case of compositions comprising such unpolymerizable additives the concentration of specified polymerized units can be as much as 5, 10, 15, 20, 25 wt-% less, depending on the total concentration of such additives. For example, when the film or composition comprises 20 wt-% inorganic filler, the concentration of low Tg monofunctional alkyl (meth)acrylate monomer may be reduced by about 20 wt-%, i.e. at about 8 wt-% less, in some embodiments about 12 wt-% less, and the like.

Disclosed compositions can include at least one high Tg monomer, e.g., a (meth)acrylate monomer when reacted to form a homopolymer has a Tg greater than 0° C. The high Tg monomer more typically has a Tg greater than 5° C., 10° C., 15° C., 20° C., 25° C., 30° C., 35° C., or 40° C.

In some embodiments, disclosed compositions can include at least one high Tg monofunctional alkyl (meth)acrylate monomers including for example, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, norbornyl (meth)acrylate, benzyl methacrylate, 3,3,5 trimethylcyclohexyl acrylate, cyclohexyl acrylate, N-octyl acrylamide, and propyl methacrylate or combinations.

In some embodiments, the film and composition comprises at least 1, 2, or 3 wt-% up to 35 wt-% of polymerized units of a monofunctional alkyl (meth)acrylate monomer having a Tg greater than 40° C., 50° C., 60° C., 70° C., or 80° C. based on the total weight of the polymerized units (i.e. excluding inorganic filler or other additives).

The Tg of the homopolymer of various monomers is known and is reported in various handbooks. The following table sets forth the Tg of some illustrative monomers as reported (unless specified otherwise) in Polymer Handbook , 4^{th} edition, edited by J. Brandrup, E. H. Immergut, and E. A. Grulke, associate editors A. Abe and D. R. Bloch, J. Wiley and Sons, New York, 1999.

TABLE 1
Glass Transition Temperature (Tg) of Monomers

| | Tg, ° C. | | Tg, ° C. |
|---|---|---|---|
| Methyl methacrylate | 105 | Methacrylic acid | 223 |
| Isobutyl methacrylate | 53 | 2-hydroxyethyl acrylate | 4 (b) |
| Hexyl methacrylate | −5 | 2-hydroxyethyl | 85 |
| | | methacrylate | |
| Methyl acrylate | 10 | N-vinyl carbazole | 212 (a) |
| Butyl acrylate | −54 | N,N-dimethyl acrylamide | 89 |
| 2-octyl acrylate | −45 | N-vinyl pyrrolidone | 54 |
| 2-ethylhexyl acrylate | −50 | N,N-Dimethylamino ethyl | −39 (a) |
| | | acrylate | |
| Isobornyl acrylate | 94 | N,N-Dimethylamino ethyl | 19 |
| | | methacrylate | |
| Acrylic acid | 106 | | |

(a) I. Sideridou-Karayannidou and G. Seretoudi, Polymer, Vol. 40, Issue 17, 1999, pp. 4915-4922.
(b) B. Aran, M. Sankir, E. Vargun, N. D. Sankir, and A. Usanmaz; Journal of Applied Polymer Science, Wiley Periodicals, Inc., A Wiley Company, 2010, Vol. 116, pp. 628-635

### Polyvinyl Acetal Resin

The polyvinyl acetal resin includes polymerized units having the formula:

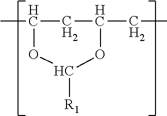

where R₁ is hydrogen or an alkyl group having 1 to 7 carbon atoms (C1-C7).

Polyvinyl acetal resins utilized in the present disclosure is obtained, for example, by reacting polyvinyl alcohol with aldehyde, as known in the art.

Polyvinyl alcohol resins are not limited by the production method. For example, those produced by saponifying polyvinyl acetate and the like with alkali, acid, ammonia water, and the like, can be used. Polyvinyl alcohol resins may be either completely saponified or partially saponified. It is preferable to use those having a saponification degree of 80 mol % or more. The polyvinyl alcohol resins may be used singly or in combination of two or more.

Aldehydes used in the production of the polyvinyl acetal resin include formaldehyde (including paraformaldehyde), acetaldehyde (including paraacetaldehyde), propionaldehyde, butyraldehyde, n-octylaldehyde, amylaldehyde, hexylaldehyde, heptylaldehyde, 2-ethylhexylaldehyde, cyclohexylaldehyde, furfural, glyoxal, glutaraldehyde, benzaldehyde, 2-methylbenzaldehyde, 3-methylbenzaldehyde, 4-methylbenzaldehyde, p-hydroxybenzaldehyde, m-hydroxybenzaldehyde, phenylacetaldehyde, B-phenylpropionaldehyde, and the like. These aldehydes may be used singly or in combination of two or more.

The polyvinyl acetal resin can also be described as including repeating units represented by Chemical Formula 1.

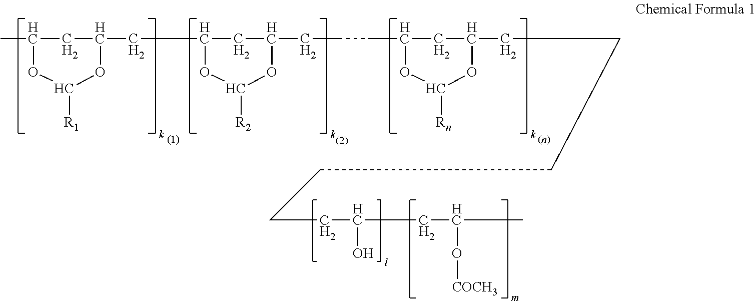

In Chemical Formula 1, n is the number of different types of aldehyde used in acetalization; R₁, R₂, . . . , Rₙ, are independently a (e.g. C1-C7) alkyl residue of aldehyde used in the acetalization reaction, or a hydrogen atom; k₁, k₂, . . . , kₙ are independently the proportion of each acetal unit containing R₁, R₂, . . . , Rₙ, (molar ratio); 1 is the proportion of vinyl alcohol units (molar ratio); and m is the proportion of vinyl acetate units (molar ratio). The sum of k₁+k₂+ . . . +kₙ+1+m=1. Further at least one of k₁, k₂, . . . , kₙ may not be zero. When a single aldehype is utilized in the preparation of the polyvinyl acetal resin, such single aldehyde may be represented by k₁, wherein k₁ is greater than 1 and sufficient to provide the desired molecular weight. In this embodiment, k₂ and kₙ may be zero. The polyacetal resin is typically a random copolymer. However, block copolymers and tapered block copolymers may provide similar benefits as random copolymers.

Disclosed compositions can include various amounts of polyvinyl acetal (e.g. butyral). For example, in some embodiments, disclosed compositions can include not less than 0.1 wt-%, not less than 0.5 wt-%, not less than 1 wt-%, not less than 5 wt-%, not less than 10 wt-%, or not less than 15 wt-% based on the total weight of the composition. For example, in some embodiments disclosed compositions can include not greater than 30 wt-%, not greater than 25 wt-%, or not greater than 20 wt-% based on the total weight of the composition. Thus, “k₁, k₂, . . . , kₙ” are selected accordingly.

In some embodiments, the alkyl residue of aldehyde comprises 1 to 7 carbon atoms. In other embodiments, the alkyl reside of the aldhehyde comprises 3 to 7 carbon atoms such as in the case of butylaldehyde (R₁=3), hexylaldehyde (R₁=5), n-octylaldehyde (R₁=7). Of these butyraldehyde, also known as butanal is most commonly utilized. Polyvinyl butyral (“PVB”) resin is commercially available from Kuraray under the trade designation “Mowital” and Solutia under the trade designation “Butvar”.

In some embodiments, the polyvinyl acetal (e.g. butyral) resin has a Tg ranging from about 60° C. up to about 75° C. or 80° C. In some embodiments, the Tg of the polyvinyl acetal (e.g. butyral) resin is at least 65 or 70° C. When other aldehydes, such as n-octyl aldehyde, are used in the preparation of the polyvinyl acetal resin, the Tg may be less than 65° C. or 60° C. The Tg of the polyvinyl acetal resin is typically at least 35, 40 or 45° C. When the polyvinyl acetal resin has a Tg of less than 60° C., higher concentrations of high Tg monomers may be employed in the film and (e.g. exemplified) composition in comparison to those utilizing polyvinyl butyral resin. When other aldehydes, such as acetaldehyde, are used in the preparation of the polyvinyl acetal resin, the Tg may be greater than 75° C. or 80° C. When the polyvinyl acetal resin has a Tg of greater than 70° C., higher concentrations of low Tg monomers may be employed in the film and (e.g. exemplified) composition in comparison to those utilizing polyvinyl acetal butyral resin.

The polyacetal (e.g. PVB) resin typically has an average molecular weight (Mw) of at least 10,000 g/mole, 15,000 g/mole or 30,000; and no greater than 100,000 g/mole, 80,000 g/mole or 60,000 g/mole.

### Initiator

Disclosed compositions also include a least one initiator to initiate crosslinking of the composition. In some embodiments, the at least one initiator can be an actinic radiation activated initiator. In some embodiments, the at least one initiator can be a thermal initiator. Illustrative actinic radiation activated initiators can include photoinitiators.

Useful photoinitiators include benzoin ethers such as benzoin methyl ether and benzoin isopropyl ether; substituted acetophenones such as 2,2-dimethoxy-2-phenylacetophenone photoinitiator, available the trade name IRGACURE 651 or ESACURE KB-1 photoinitiator (Sartomer Co., West Chester, Pa.), and dimethylhydroxyacetophenone; substituted α-ketols such as 2-methyl-2-hydroxy propiophenone; aromatic sulfonyl chlorides such as 2-naphthalene-sulfonyl chloride; and photoactive oximes such as 1-phenyl-1,2-propanedione-2-(O-ethoxy-carbonyl)oxime. Particularly preferred among these are the substituted acetophenones.

Preferred photoinitiators are photoactive compounds that undergo a Norrish I cleavage to generate free radicals that can initiate by addition to the acrylic double bonds. The photoinitiator can be added to the mixture to be coated after the polymer has been formed, e.g., photoinitiator can be added to the composition. Such polymerizable photoinitiators are described, for example, in U.S. Pat. Nos. 5,902,836 and 5,506,279 (Gaddam et al.).

Such photoinitiators are typically present in an amount of from 0.1 to 1.0 wt-% based on the total weight of the composition.

### Optional Components

In some disclosed embodiments, compositions can also include other optional components.

One such optional component includes one or more polar functional monomers. Such polar functional monomers may aid in compatibilizing the polyvinyl acetal (e.g. butyral) resin with the (meth)acrylate ester monomer. In some embodiments, the polar functional monomers may have a Tg greater than 0° C., yet the Tg may be less than the high Tg monofunctional alkyl (meth)acrylate monomer.

Representative polar functional monomers include for example acid-functional monomers, hydroxyl functional monomers, nitrogen-containing monomers, and combinations thereof.

In some embodiments, disclosed compositions can include polymerized units of an acid functional monomer (a subset of high Tg monomers), where the acid functional group may be an acid per se, such as a carboxylic acid, or a portion may be salt thereof, such as an alkali metal carboxylate. Useful acid functional monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido-2-methylpropanesulfonic acid, vinylphosphonic acid, and mixtures thereof.

Due to their availability, acid functional monomers are generally selected from ethylenically unsaturated carboxylic acids, i.e. (meth)acrylic acids. When even stronger acids are desired, acidic monomers include the ethylenically unsaturated sulfonic acids and ethylenically unsaturated phosphonic acids.

In some embodiments, the film and composition comprises non-acid-functional polar monomer.

One class of non-acid-functional polar monomers includes nitrogen-containing monomers. Representative examples include N-vinylpyrrolidone; N-vinylcaprolactam; acrylamide; mono- or di-N-alkyl substituted acrylamide; t-butyl acrylamide; dimethylaminoethyl acrylamide; and N-octyl acrylamide.

Another class of non-acid-functional polar monomers includes alkoxy-functional (meth)acrylate monomers. Representative examples 2-(2-ethoxyethoxy)ethyl (meth)acrylate, 2-ethoxyethyl (meth)acrylate, 2-hydroxyethyl (meth)acrylate, 2-methoxyethoxyethyl (meth)acrylate, 2-methoxyethyl methacrylate, and polyethylene glycol mono(meth)acrylates.

In some embodiments, polar functional monomers can include acrylic acid, 2-hydroxyethyl (meth)acrylate; N,N-dimethyl acrylamide, N-vinylpyrrolidinone, or combinations thereof.

Polar functional monomers can be present in disclosed compositions in various useful amounts. In some embodiments, polar functional monomers can be present in disclosed compositions in an amount that is not less than 1 wt-%, 1.5 wt %, or 2 wt-% based on the total weight of the composition. In some embodiments, polar functional monomers can be present in disclosed compositions in an amount that is not greater than 15 wt-%, 12 wt-%, or 10 wt-% based on the total weight of the composition.

Another optional component includes adhesion promoters. Disclosed compositions need not, but can include adhesion promoters. In some embodiments disclosed compositions do not include adhesion promoters and in some embodiments disclosed compositions do include adhesion promoters. In some embodiments, disclosed compositions have desirable adhesion properties without the need for adhesion promoters.

Illustrative adhesion promoters can include silane coupling agents. Illustrative specific examples of the silane coupling agent can include aminosilanes such as N-β(aminoethyl)γ-aminopropyltrimethoxysilane, γ-aminopropyltrimethoxysilane, γ-aminopropyltriethoxysilane, N-phenyl-γ-aminopropyltrimethoxysilane, etc., thiolsilane, epoxysilane, ureasilane and the like. The amount of the optional coupling agent contained in the composition is usually within a range from 0.02 to 5% by weight, from 0.05 to 3% by weight, or from 0.1 to 2% by weight, based on the total weight of the composition.

### Articles

Also disclosed herein are articles that include or are made using disclosed compositions. Disclosed compositions can be useful in forming virtually any types of articles. In some embodiments, illustrative types of articles can include, for example layered articles. Disclosed compositions and articles made using disclosed compositions may offer advantageous properties including, for example typically adhesive type properties, wearability, optical properties, flexibility, washability, or any combinations thereof.

In some embodiments, articles made using or that include disclosed compositions can include retroreflective articles. A wide variety of articles that incorporate the phenomenon of retroreflectivity have been developed for a wide array of uses. Retroreflective articles have the ability to return a substantial portion of incident light back towards the light source. This unique ability has promoted widespread use of retroreflective safety articles. Besides traffic and warning signs and the like, a wide variety of clothing and similar articles such as backpacks, and the like have incorporated retroreflective articles into them. Persons who work or exercise near motor vehicle traffic need to be conspicuously visible so that they do not get struck by passing motor vehicles. When retroreflective articles are worn, the retroreflectivity highlights a person's presence by retroreflecting light from motor vehicle headlamps.

Retroreflective articles typically have an optical lens element layer, a polymeric bead bond layer, a reflective layer, and may also have a substrate layer. The optical lens elements commonly are microsphere beads that are partially embedded in the polymeric bead bond layer. The reflective layer typically is aluminum, silver, or a dielectric mirror that usually is disposed on the embedded portions of the microsphere beads. Light striking the front surface of the retroreflective article passes through the microsphere beads and is reflected by the reflective layer to re-enter the microsphere beads where the light's direction is then altered to travel back towards the light source. Thus, for example, when a vehicle's headlamps strike a retroreflective article, some of the light from the headlamps is reflected back to the driver of the vehicle.

It is generally not necessary, or even desirable, that an entire worn article be retroreflective, so retroreflective appliques are often used. These retroreflective appliques can then be attached to an article of clothing or other article to prepare a retroreflective article. In some instances, retroreflective appliques have been made by partially embedding a microsphere layer in a thermoplastic carrier web, applying a reflective material over the microsphere beads' protruding portions, and then forming a bead bond layer over the coated microsphere beads. Often a hot melt adhesive is applied on the bead bond layer's back surface, and a release liner is placed over the adhesive until the applique is secured to a substrate. This type of applique, a transfer film applique, is supplied to a garment assembler in this form, and the garment assembler secures the applique to an article of clothing by removing the release liner and laminating the applique to an outer surface of the article of clothing. The carrier is then separated from the applique to expose the microsphere beads so that the applique can retroreflect light.

A different type of applique, referred to herein as a fixed applique, consists of a retroreflective article permanently applied to a fabric or material with the bead layer exposed. The fixed applique can be sewn onto, or otherwise attached to, a garment or other item.

A variety of articles are retroreflective or have retroreflective appliques that combine retroreflectivity with bright or fluorescent colors. Often articles have strips of retroreflective material and adjacent stripes of bright or fluorescent colors. In this way the articles provide high visibility in daylight due to the brightly colored or fluorescent strips and also are retroreflective for high visibility at night. An example is an article having two fluorescent yellow strips with a retroreflective strip located between the fluorescent yellow strips.

Retroreflectivity of an article can be expressed in terms of its coefficient of retroreflectivity (R_{A})

$${R}_{A} = {E}_{r} \times \frac{{d}^{ 2}}{{E}_{S}} \times A$$

R_{A}=retroreflective intensity
Eᵣ=illumination incident upon the receiver
Eₛ=illumination incident upon a plane perpendicular to the incident ray of the specimen position, measured in the same units as Eᵣ
d=distance from the specimen to the projector
A=area of the test surface

The coefficient of retroreflectivity (R_{A}) is further described in U.S. Pat. No. 3,700,305 (Bingham). In at least some embodiments, the articles of the present disclosure have an R_{A} of at least 50, in other embodiments an R_{A} of at least 100, in other embodiments, an R_{A} of at least 200, and in other embodiments, an R_{A} of at least 300.

Another aspect of retroreflective articles is their ability to maintain retroreflectivity and color quality after being washed a number of times. In at least some embodiments, articles of the present disclosure have a minimum R_{A} value of at least 100 after fifty washes using ISO 6330 Method 2A.

Disclosed herein are methods of preparing retroreflective articles. These methods comprise providing a polymeric carrier layer with a first major surface and a second major surface, providing transparent microspheres, partially embedding the transparent microspheres into the first major surface of the polymeric carrier layer such that the beads at least partially protrude from the first major surface of the polymeric carrier layer to form a layer of microspheres, depositing one or more reflective layers on at least a portion of the first major surface of the polymeric carrier layer and the layer of microspheres, applying a composition to the layer of microspheres, and curing the composition to form a bead bond layer. The composition can be an adhesive composition disclosed herein or any adhesive composition. The thus formed article can be considered an intermediate article and can be transformed into a retroreflective article by removing the polymeric carrier layer.

In some embodiments, depositing one or more reflective layers on at least a portion of the first major surface of the polymeric carrier layer and the layer of microspheres comprises depositing a layer of reflective metal to a selected portion of the layer of microspheres. This selective deposition can be achieved in a variety of ways, for example, portions of the surface can be masked to prevent the deposition of the metal. In other embodiments, depositing one or more reflective layers on at least a portion of the first major surface of the polymeric carrier layer comprises depositing one or more layers of dielectric material on a selected portion of the layer of microspheres. Generally, multiple layers of dielectric material are deposited to form the dielectric reflecting layer, which is sometimes called a dielectric mirror. A combination of these types of deposition can also be used.

A wide variety of materials are suitable for use in the methods described above. Examples of these materials are described below.

A wide variety of materials and combinations of materials are suitable for the polymeric carrier layer. In many embodiments the polymeric carrier layer is a thermoplastic polymeric carrier layer, but in other embodiments the polymeric carrier layer may comprise an elastomeric polymeric carrier layer, and in some embodiments may even be a pressure sensitive adhesive or a heat activated adhesive. Typically the polymeric carrier layer comprises a thermoplastic polymeric carrier layer. In some embodiments, the thermoplastic polymeric carrier layer may be a standalone layer; in other embodiments the thermoplastic polymeric carrier layer may comprise a coating of thermoplastic polymeric carrier material on the first major surface of a sheet. The sheet may comprise, for example, paper, a polymeric film, and the like. Examples of useful polymeric carrier materials include polyvinyl chloride, polysulfones, polyalkylenes such as polyethylene, polypropylene and polybutylene, polyesters, and the like.

A layer of partially embedded transparent microspheres is formed on the surface of the polymeric carrier layer. The monolayer of transparent microspheres can be assembled by cascading transparent microspheres onto the polymeric carrier layer, which secures the microspheres in a desired temporary assignment. Typically, the polymeric carrier layer can be heat softened. The microspheres are generally packed as closely as possible, ideally in their closest hexagonal arrangement, to achieve very good retroreflective brightness and may be so arranged by any convenient application process, such as printing, screening, cascading, or hot rolling. Upon cooling, the polymeric carrier layer retains the microspheres in a desired arrangement.

Typically, the transparent microspheres are substantially spherical in shape in order to provide the most uniform and efficient retroreflection. The microspheres are substantially transparent so as to minimize absorption of light so that a large percentage of the incident light is retroreflected. The microspheres often are substantially colorless but may be tinted or colored in some other fashion.

The microsphere beads may be made from glass, a non-vitreous ceramic composition, or a synthetic resin. Glass and ceramic microspheric beads are particularly suitable because they tend to be harder and more durable than microsphere beads made from synthetic resins. Examples of microsphere beads that may be used are described in the following U.S. Pat. Nos. 1,175,224, 2,461,011, 2,726,161, 2,842,446, 2,853,393, 2,870,030, 2,939,797, 2,965,921, 2,992,122, 3,468,681, 3,946,130, 4,192,576, 4,367,919, 4,564,556, 4,758,469, 4,772,511, and 4,931,414.

The microspheres typically have an average diameter in the range of about 30 to 200 micrometers. Microspheres smaller than this range tend to provide lower levels of retroreflection, and microspheres larger than this range may impart an undesirably rough texture to the appliqué or may undesirably reduce its flexibility. The microspheres typically have a refractive index of about 1.7 to about 2.0, the range typically considered to be useful in exposed lens retroreflective products.

As described above, a reflective layer is applied to at least a portion of the microsphere layer. The reflective layer may be a reflective metal layer, a dielectric reflective layer, or a combination thereof. The reflective layer can be described as being functionally located between the layer of optical elements and the bead bond layer

The reflective metal layer is a specularly reflective metal that forms a reflective metal layer coating. This technique facilitates the arrangement of the retroreflective elements (optical elements and reflective material) in substantially uniform direction for retroreflection. The size of the retroreflective elements, i.e. the surface portion of the microspheres covered with the reflective material, may be controlled in part by controlling the depth to which the microspheres are embedded in the polymer prior to applying the reflective material.

The reflective material can be a layer comprising an elemental metal that is capable of specularly reflecting light. A variety of metals may be used to provide a specular reflective metal layer. These include aluminum, silver, chromium, gold, nickel, magnesium, and the like, in elemental form, and combinations thereof. Aluminum and silver are particularly suitable metals for use in a reflective layer from a performance standpoint. The metal may be a continuous coating such as is produced by vacuum-deposition, vapor coating, chemical-deposition, or electroless plating. It is to be understood that in the case of aluminum, some of the metal may be in the form of the metal oxide and/or hydroxide. Aluminum and silver metals are desirable because they tend to provide the highest retroreflective brightness. The metal layer should be thick enough to reflect incoming light. Typically, the reflective metal layer is about 50 to 150 nanometers thick.

The dielectric reflective layer is a dielectric mirror. The dielectric mirror may be similar to known dielectric mirrors disclosed in U.S. Pat. Nos. 3,700,305 and 4,763,985 to Bingham. The dielectric mirrors typically are multi-layer constructions, with a layer having a refractive index n₂ and a layer of transparent material disposed thereon which has a refractive index n₁, and the opposite face of the transparent material (having a refractive index n₁) is in contact with a material having a refractive index n₃, where both n₂ and n₃ have a refractive index of at least 0.1, more typically at least 0.3, higher or lower than n₁. The transparent material is a layer that typically has an optical thickness corresponding to odd numbered multiples (that is, 1, 3, 5, 7 . . . ) of about one-quarter wavelength of light in the wavelength range of about 380 to about 1,000 nanometers. Thus, either n₂>n₁<n₃ or n₂<n₁>n₃, and the materials on either side of the transparent layer may be either both higher or both lower in refractive index than n₁. When n₁ is higher than both n₂ and n₃, n₁ is in the 1.7 to 4.9 range, and n₂ and n₃ are in the 1.2 to 1.7 range. Conversely, when n₁ is lower than both n₂ and n₃, n₁ is in the 1.2 to 1.7 range, and n₂ and n₃ are in the 1.7 to 4.9 range. The dielectric mirror generally comprises a contiguous array of materials, at least one being in layer form, having an alternating sequence of refractive indices. Typically, the contiguous array has from two to seven layers, more typically three to five layers, adjacent to the lens element. A dielectric mirror can provide very good retroreflectivity, although, it typically is not as efficient a reflector as a reflective metal layer.

Among the many compounds that may be used in providing transparent materials within the desired refractive index range are: high index materials such as CdS, CeO₂, CsI, GaAs, Ge, InAs, InP, InSb, ZrO₂, Bi₂O₃, ZnSe, ZnS, WO₃, PbS, PbSe, PbTe, RbI, Si, Ta₂O₅, ZrO₂, Te, TiO₂, low index materials such as cryolite, Al₂O₃, A₁F₃, CaF₂, CeF₃, LiF, MgF₂, Na₃AlF₆, ThOF₂, elastomeric copolymers of perfluoropropylene and vinylidene fluoride (refractive index of >>1.38), etc. Other materials are reported in Thin Film Phenomena, K. L. Chopra, page 750, McGraw-Hill Book Company, N.Y., (1969). Particularly suitable dielectric mirrors contain layers of SiO₂, CaF₂, MgF₂, ZnS, Nb₂O₅, Ta₂O₅, ZrO₂, or combinations thereof. In some embodiments, the dielectric reflective layer comprises a layer of CaF₂, ZnS, or a combination thereof.

Bead bond layers may contain at least one polymer (typically called a binder material) and may contain additional additives such as a colorant or other optional additives such as UV stabilizers, antioxidants, UV absorbers, property modifiers, performance enhancers, or combinations thereof. Any of the colorants described above (nanopigments, dyes, and pigments) are suitable for use in the bead bond layer.

The polymeric binder material of the bead bond layer may be a polymer including, but not limited to, an elastomer. In this disclosure, an elastomer is defined as a polymer having an ability to be stretched to at least twice its original length and to retract to approximately its original length when released, (definition taken from “Hawley's Condensed Chemical Dictionary”, R. J. Lewis Sr. Ed., 12th Ed., Van Nostrand Reinhold Co., New York, N.Y. (1993)). Typically, the polymeric binder material includes a cross-linked or virtually cross-linked elastomer. A cross-linked elastomer means that the polymeric chains of the elastomer are chemically cross-linked to form a three dimensional network which is stabilized against molecular flow. A virtually cross-linked elastomer means that the polymeric chain mobility of the elastomer is greatly reduced by chain entanglement and/or by hydrogen bonding, resulting in an increase in the cohesive or internal strength of the polymer. Examples of such polymer cross-linking include carbon-carbon bond formation such as: free radical bonding between vinyl groups between chains; agent or group coupling such as by vulcanization or reaction with a coupling agent such as a diol in the case of isocyanate or epoxy functionalized polymers; a diisocyanate or an activated ester in the case of amine and alcohol functionalized polymers; and epoxides and diols in the case of carboxylic acid or anhydride functionalized polymers. Examples of such virtual cross-linking include amide hydrogen bonding as is found in polyamides or crystalline and amorphous region interactions as is found in block copolymers of styrene and acrylonitrile.

Illustrative examples of the polymers that may be employed as the binder material in the bead bond layer include: polyolefins; polyesters; polyurethanes; polyepoxides; natural and synthetic rubbers; and combinations thereof. Examples of cross-linked polymers include the foregoing examples of polymers substituted with cross-linkable groups such as epoxide groups, olefinic groups, isocyanate groups, alcohol groups, amine groups or anhydride groups. Multifunctional monomers and oligomers which react with functional groups of the polymers may also be used as cross-linkers.

Specific examples of useful bead bond layer materials are disclosed in U.S. Pat. Nos. 5,200,262 and 5,283,101. In the '262 patent, the bead bond layer comprises one or more flexible polymers having active hydrogen functionalities such as crosslinked urethane-based polymers (for example, isocyanate cured polyesters or one of two component polyurethanes) and one or more isocyanate-functional silane coupling agents. In the '101 patent, the bead bond layer comprises an electron-beam cured polymer selected from the group consisting of chlorosulfonated polyethylenes, ethylene copolymers comprising at least about 70 weight percent polyethylene, and poly(ethylene-co-propylene-co diene) polymers.

Examples of commercially-available polymers that may be used in the bead bond layer include the following: VITEL VPE 3550B and VPE 5833 polyesters available from Bostik, Wauwatosa, Wis.; RHOPLEX HA-8 and NW-1845 acrylic resins available from Dow Chemical; CYDROTHANE a polyurethane available from Cytec Industries, West Patterson, N.J.; ESTANE 5703 and 5715 available from Lubrizol Corporation, Cleveland, Ohio; and NIPOL 1000, available from Zeon Chemicals, Inc., Rolling Meadows, Ill.

The bond layer typically has a thickness of about 50 to 250 micrometers (2 to 10 mils), with thicknesses of about 75 to 200 micrometers (3 to 8 mils) often being particularly suitable. It is to be understood that a bead bond layer having a thickness outside these ranges may be used; however, if the bead bond layer is too thin, it may not provide sufficient support to the microsphere beads, allowing them to become dislodged.

If colored, the bead bond layer generally includes a desirable amount of colorant to provide supplemental color or depth of color of the polymeric color layer or article. The amount of colorant in the polymeric color layer can depend at least in part on the particular colorant(s) used, the desired color or shade of color, the other components in the polymeric color layer, and combinations thereof.

In some embodiments, the method may further include use of an application layer to the bead bond layer. The application layer can be contacted to the bead bond layer prior to curing, that is to say, that the application layer can be contacted to the composition or a disclosed adhesive composition, such that when the composition or disclosed adhesive composition cures the bead bond layer is adhered to the application layer. The application layer can be a single layer or multi-layer article. Examples of suitable application layers include a film layer, a fabric layer, or a non-woven layer.

In other embodiments, the application layer can be contacted to the bead bond layer after curing. Examples of suitable application layers include a layer of adhesive, a film layer, a fabric layer, or a non-woven layer. Examples of suitable adhesives include pressure sensitive adhesives, heat activated adhesives and laminating adhesives. The adhesive layer can be covered by a release liner if desired to protect the adhesive surface from contamination until used. The adhesive layer can be used alone as the application layer or the adhesive layer can be used to adhere the bead bond layer to a wide range of substrates such as films, fabrics and non-wovens. In addition, a wide range of substrates such as films, fabrics and non-wovens can be adhered to the bead bond layer by mechanical means such as by heat lamination. Particularly desirable substrates are fabrics so that the formed article is an article of clothing.

The thus formed articles are sometimes called “intermediate articles”. By intermediate articles it is meant articles in which the polymeric carrier layer is attached to the article. The intermediate articles are not themselves retroreflective articles, but become retroreflective articles upon the removal of the polymeric carrier layer.

The intermediate article can be immediately subjected to additional steps to generate the final retroreflective article, or the intermediate article can be stored for later use, shipped to another location, or subjected to additional processing steps such as cutting, attachment to a substrate, and the like. It is often desirable to form this intermediate article, because this intermediate article can be stored, shipped, or processed without exposing the optical elements. Once the optical elements are exposed, even though they contain a bead bond layer, they are subject to potential damage from abrasion, staining and the like. When desired, the polymeric carrier layer can be removed to form the final retroreflective article.

The above methods can be used to prepare a wide variety of retroreflective articles. Disclosed herein are retroreflective articles that comprise a layer of optical elements. The optical elements are transparent microspheres, and at least one reflective layer. The optical elements are embedded in a bead bond layer, where the bead bond layer is a curable composition or a disclosed adhesive composition. The reflective layer may be a reflective metal layer, a dielectric reflective layer, or a combination thereof.

The retroreflective articles have wash durability. By wash durability it is meant that the retroreflective articles of this disclosure are capable of being laundered without losing the desired properties of the article, namely retroreflectivity (R_{A}). Wash durability of retroreflective articles can be described in a variety of different ways. An example of good washing performance was described in US Patent Publication No. 2011/0292508 (Huang et al.), as retaining at least about 100 candelas/lux/meter² at 5/0.2 angle after being washed 15 times. In some embodiments, the retroreflective article can retain at least about 200 candelas/lux/meter² at 5/0.2 angle after being washed 15 times. In yet other embodiments, the retroreflective article can retain at least about 300 candelas/lux/meter² at 5/0.2 angle after being washed 15 times.

In some embodiments, it is desirable that the retroreflective articles have at least a portion of the surface of the article be discontinuous. By discontinuous it is meant that there is a region in the finished retroreflective article that is devoid of all layers from the microsphere bead and barrier material layer and to the bead bond layer. These discontinuities can be beneficial for a variety of reasons. In some embodiments, the discontinuities can form a pattern or design. The pattern or design can be in the form of indicia, logos, etc. In other embodiments, the discontinuities can be arranged either randomly or in a non-continuous pattern. Besides the visual effect of the discontinuities, the discontinuities can provide enhanced breathability for the retroreflective article. By this it is meant that gases, and or moisture can pass through the retroreflective article more easily. An effect of the enhanced breathability is to be more comfortable for a person wearing such an article. This is particularly desirable for construction workers, firefighters, emergency workers, and people exercising.

Retroreflective articles with discontinuous segments can be prepared a variety of different ways. A particularly suitable way involves partially removing optical elements and bead bond layer from portions of one or more segments. This removal can be effected by cutting, scraping, hole-punching, and other suitable mechanical means.

Examples of articles of this disclosure are provided in the Figures. FIG. 1 is a cross sectional depiction of an embodiment of an intermediate article of this disclosure. In FIG. 1, the intermediate article includes bead bond layer 10, transparent microspheres 20, reflective layer 30 and carrier layer 40. Carrier layer 40 includes sheet layer 44 and a coating of thermoplastic polymeric carrier material 42.

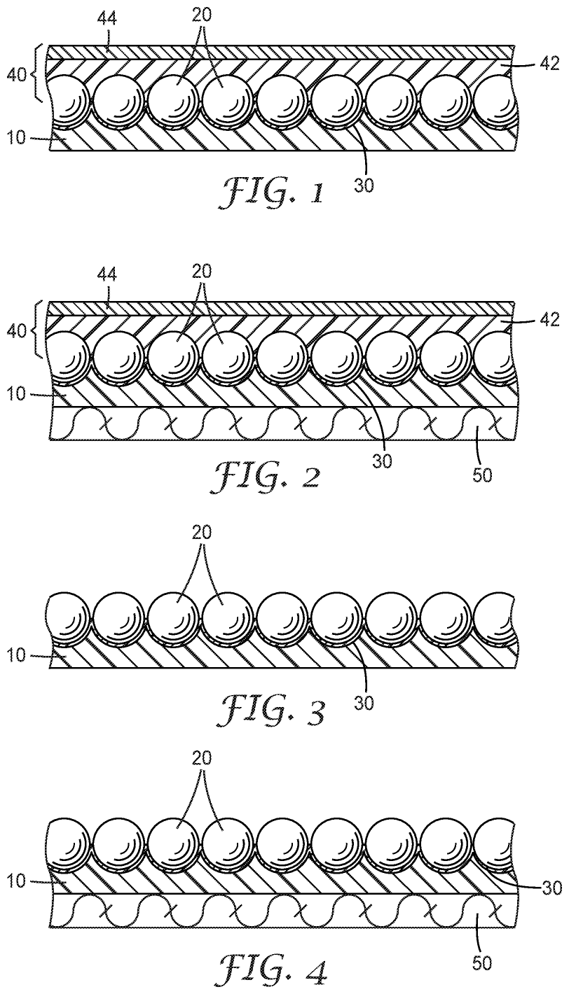

FIG. 2 depicts an alternative embodiment of an intermediate article of this disclosure. In FIG. 2, the intermediate article includes bead bond layer 10, transparent microspheres 20, reflective layer 30 and application layer 50. Application layer 50 could be or could include an adhesive, a fabric, or a non-woven.

FIG. 3 depicts the embodiment of FIG. 1 in which the carrier layer 40 has been removed. In FIG. 3, the article includes bead bond layer 10, transparent microspheres 20, and reflective layer 30.

FIG. 4 depicts the embodiment of FIG. 2 in which the carrier layer 40 has been removed. In FIG. 4, the article includes bead bond layer 10, transparent microspheres 20, reflective layer 30, and application layer 50.

Also disclosed herein are articles of clothing that contain retroreflective appliques of the disclosure. These articles of clothing comprise a fabric with a first major surface and a second major surface, and a retroreflective applique attached to the first major surface of the fabric. The retroreflective applique is the retroreflective article described above. A wide variety of fabrics are suitable.

Transfer film retroreflective appliques and fixed retroreflective applique can be attached to the fabric surface by a wide range of attachment techniques such as mechanical attachment or adhesive attachment. Examples of mechanical attachment techniques include, for example, sewing and heat lamination. In adhesive attachment, an adhesive can be applied to the bead bond layer or a backing layer can be applied to the bead bond layer and an adhesive layer applied to the backing layer. In some embodiments, such adhesives can include disclosed adhesive compositions.

Examples of suitable adhesive layers include (in addition to disclosed adhesive compositions) pressure sensitive adhesives, heat activated adhesives, and laminating adhesives. The adhesive layer may be applied to the bead bond layer or backing layer by coating or by lamination of a formed adhesive layer to the bead bond layer or backing layer. A wide variety of pressure sensitive adhesives are suitable including tackified natural rubbers, synthetic rubbers, tackified styrene block copolymers, polyvinyl ethers, poly (meth)acrylates, polyurethanes, polyureas, poly-alpha-olefins, and silicones. The pressure sensitive adhesive may be covered with a release liner to protect the adhesive prior to adhesion to a substrate.

Heat activated adhesives are very similar to pressure sensitive adhesives but require the application of heat to become tacky. One advantage of heat activated adhesives is that, because they are not tacky at room temperature, they typically do not require a release liner to protect the adhesive layer prior to adhesion to a substrate.

Typically, if a laminating adhesive is used, the adhesive layer is immediately bonded to a substrate to form the adhesive substrate bond. Examples of laminating adhesives include hot melt adhesives, adhesive dispersions and suspensions, and curing adhesives such as cyanoacrylates.

A wide variety of articles of clothing are suitable for attachment of retroreflective appliques. Examples of such articles of clothing include, for example, vests such as the safety vests frequently worn by road construction workers, but also include a wide range of other clothing types. Examples include, shirts, sweaters, jackets, coats, pants, shorts, socks, shoes, gloves, belts, hats, suits, one-piece body garments, and the like.

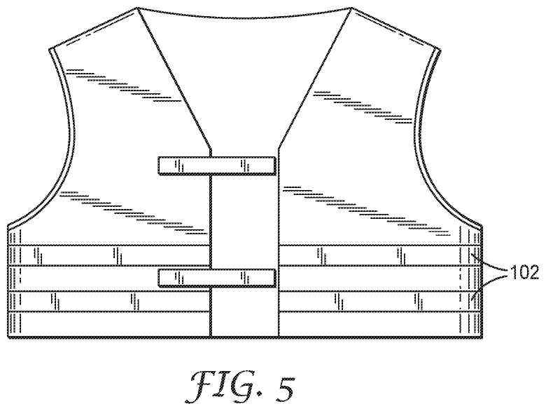

FIG. 5 depicts an article of clothing of this disclosure. The vest in FIG. 5 includes retroreflective appliqués 102. The retroreflective appliqués 102 can be, for example an article of FIG. 1.

All scientific and technical terms used herein have meanings commonly used in the art unless otherwise specified. The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise. The term “and/or” means one or all of the listed elements or a combination of any two or more of the listed elements.

As used herein, “have”, “having”, “include”, “including”, “comprise”, “comprising” or the like are used in their open ended sense, and generally mean “including, but not limited to”. It will be understood that “consisting essentially of”, “consisting of”, and the like are subsumed in “comprising” and the like. For example, a composition that “comprises” silver may be a composition that “consists of” silver or that “consists essentially of” silver.

As used herein, “consisting essentially of,” as it relates to a composition, apparatus, system, method or the like, means that the components of the composition, apparatus, system, method or the like are limited to the enumerated components and any other components that do not materially affect the basic and novel characteristic(s) of the composition, apparatus, system, method or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Also herein, the recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” a particular value, that value is included within the range.

Use of “first,” “second,” etc. in the description above and the claims that follow is not intended to necessarily indicate that the enumerated number of objects is present. For example, a “second” substrate is merely intended to differentiate from another substrate (such as a “first” substrate). Use of “first,” “second,” etc. in the description above and the claims that follow is also not necessarily intended to indicate that one comes earlier in time than the other.

As used herein, “polymer” is inclusive of a homopolymer, copolymer, terpolymer, and the like.

Illustrative disclosed embodiments are provided below.

Some illustrative embodiments can include adhesive compositions that comprise polymerized units of one or more (meth)acrylate ester monomers derived from an alcohol containing 1 to 14 carbon atoms; polyvinyl acetal resin; and at least one initiator.

Such compositions, wherein the alcohol containing 1 to 14 carbon atoms is selected from: esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol; 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, or combinations thereof. Such compositions, wherein the polymerized units of one or more (meth) acrylate ester monomers are selected from: ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, 2-octyl acrylate, isooctyl acrylate, isononyl acrylate, decyl acrylate, isodecyl acrylate, lauryl acrylate, isotridecyl acrylate, octadecyl acrylate, dodecyl acrylate, and combinations thereof. Such compositions, wherein the polymerized units of one or more (meth) acrylate ester monomers are selected from: 2-ethylhexyl (meth)acrylate, isooctyl (meth)acrylate, n-octyl (meth)acrylate, 2-octyl (meth)acrylate, isodecyl (meth)acrylate, and lauryl (meth)acrylate and combinations thereof. Such compositions, wherein at least some of the polymerized units of one or more (meth)acrylate ester monomers derived from an alcohol containing 1 to 14 carbon atoms comprise monomers when reacted to form a homopolymer has a Tg no greater than 0° C. Such compositions, wherein the monomer when reacted to form a homopolymer has a Tg no greater than 0° C. has the formula:

H₂C═CR¹C(O)OR⁸

where R¹ is H or methyl and R⁸ is an alkyl with 1 to 22 carbons or a heteroalkyl with 2 to 20 carbons and 1 to 6 heteroatoms selected from oxygen or sulfur. Such compositions, wherein the monomer when reacted to form a homopolymer has a T_{g} no greater than 0° C. is selected from: ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, 2-octyl acrylate, isooctyl acrylate, isononyl acrylate, decyl acrylate, isodecyl acrylate, lauryl acrylate, isotridecyl acrylate, octadecyl acrylate, dodecyl acrylate, and combinations thereof. Such compositions, wherein the monomer when reacted to form a homopolymer has a Tg no greater than 0° C. is selected from: 2-ethylhexyl (meth)acrylate, isooctyl (meth)acrylate, n-octyl (meth)acrylate, 2-octyl (meth)acrylate, isodecyl (meth)acrylate, lauryl (meth)acrylate, and combinations thereof. Such compositions, wherein at least some of the polymerized units of one or more (meth)acrylate ester monomers derived from an alcohol containing 1 to 14 carbon atoms comprise monomers when reacted to form a homopolymer has a Tg greater than 0° C. Such compositions, wherein the monomer when reacted to form a homopolymer has a Tg greater than 0° C. is selected from: t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, norbornyl (meth)acrylate, benzyl methacrylate, 3,3,5 trimethylcyclohexyl acrylate, cyclohexyl acrylate, N-octyl acrylamide, and propyl methacrylate and combinations thereof. Such compositions, wherein the polyvinyl acetal resin comprises polymerized units having the formula:

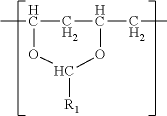

wherein R₁ is hydrogen or a C1-C7 alkyl group. Such compositions, wherein the composition comprises 0.1 to 25 wt-% of polyvinyl acetal resin based on the total weight of the composition, 10 to 25 wt-% of polyvinyl acetal resin based on the total weight of the composition, or 15 to 20 wt-% of polyvinyl acetal resin based on the total weight of the composition. Such compositions, wherein the polyvinyl acetal resin has an average molecular weight of 10,000 to 100,000 g/mole, or 30,000 to 60,000 g/mole. Such compositions, wherein the actinic radiation initiator is a photoinitiator. Such compositions further comprising a polar functional monomer. Such compositions, wherein the polar functional monomer comprises acrylic acid. Such compositions, wherein the adhesive composition comprises 1 to 15 wt-% polar functional monomer, 1.5 to 12 wt-% polar functional monomer, or 2 to 10 wt-% polar functional monomer based on the total weight of the adhesive composition. Such compositions further comprising one or more silane coupling agents. Such compositions, wherein the adhesive composition does not include a silane coupling agent.

Some illustrative embodiments can include articles comprising: at least one application layer; at least one bead bond layer; a layer of optical elements that are partially embedded in the at least one bead bond layer; and at least one reflective layer that is located functionally between the layer of optical elements and the bead bond layer, wherein the at least one bead bond layer, the at least one application layer, or both comprise a cured product of disclosed adhesive compositions.

Such articles, wherein the at least one bead bond layer comprises the cured product of the adhesive composition according to disclosed adhesive compositions. Such articles, wherein the adhesive composition comprises 0.5 to 25 wt-% polyvinyl acetal resin based on the total weight of the adhesive composition. Such articles, wherein the adhesive composition comprises 1 to 15 wt% of a polar functional monomer based on the total weight of the adhesive composition. Such articles, wherein the at least one application layer comprises the cured product of the adhesive composition according to disclosed compositions. Such articles, wherein the adhesive composition comprises 8 to 15 wt-% of polyvinyl acetal resin based on the total weight of the adhesive composition. Such articles, wherein the adhesive composition comprises 1 to 15 wt-% polar functional monomer based on the total weight of the adhesive composition. Such articles, wherein both the at least one bead bond layer and the at least one application layer comprise the cured product of the composition according to disclosed compositions. Such articles, wherein the at least one bead bond layer and the at least one application layer comprise the same composition. Such articles, wherein the at least one bead bond layer and the at least one application layer were applied in a single step. Such articles, wherein the at least one bead bond layer and the at least one application layer were cured in a single step. Such articles, wherein the application layer comprises fabric. Such articles, wherein the fabric can be woven or non-woven. Such articles, wherein the at least one bead bond layer further comprises fillers. Such articles, wherein the at least one bead bond layer further comprises modifiers. Such articles, wherein the modifiers are selected from: adhesion promoters, pigments, or combinations thereof. Such articles, wherein the adhesion promoters comprise one or more silane coupling agent. Such articles, wherein the at least one bead bond layer does not include silane coupling agents. Such articles, wherein the adhesive composition is cured using actinic energy. Such articles, wherein the actinic energy comprises visible light, ultraviolet (UV) light, e-beam energy, or combinations thereof. Such articles, wherein the adhesive composition is cured via a single application of energy. Such articles, wherein the adhesive composition is cured via more than one application of energy.

### EXAMPLES

Objects and advantages may be further illustrated by the following examples, but the particular materials and amounts thereof recited in these examples, as well as other conditions and details, should not be construed to unduly limit this disclosure.

TABLE 2

| Materials | Abbreviation | Supplier |
|---|---|---|
| 2-ethylhexyl acrylate | EHA | BASF |
| iso-bornyl acrylate | IBOA | San Esters |
| Acrylic acid | AA | BASF |
| 2-hydroxyethyl acrylate | HEA | BASF |
| dicyclopentadienyl acrylate | DPA | BASF |
| Trimethylolpropane triacrylate | TMPTA | Sartomer |
| Mowital B30HH, poly(vinyl butyral) | PVB-B30HH | Kuraray |
| Mowital B30H, poly(vinyl butyral) | PVB-B30H | Kuraray |
| Mowital B60HH, poly(vinyl butyral) | PVB-B60HH | Kuraray |
| Mowital B60H, poly(vinyl butyral) | PVB-B60H | Kuraray |
| Sartomer CN965 | CN965 | Sartomer |
| | | Americas |
| Uniplex 400 | Uniplex 400 | Lanxess USA |
| Irgacure 819 | Irg 819 | BASF |
| (Phosphine oxide, phenylbis(2,4,6- | | |
| trimethylbenzoyl)-mixture of: | | |
| 5-chloro-2-methyl-2H-isothiazol-3-one | | |
| and 2-methyl-2H-isothiazol-3-one (3:1) | | |
| Irgacure 651 | Irg 651 | BASF |
| (2,2-dimethoxy-1,2-diphenyl ethan-1-one) | | |

### Preparation of Coating Syrup Formulations

The base film formulations were prepared with the contents listed in each table in either a 1 gallon (3.79 liters) or 1 quart (0.95 liter) glass jar and mixing with a high shear electric motor (Netzsch Model 50 Dispersator) until a clear and homogenous solution was obtained.

For coating the formulations, the appropriate base film formulation and additional components as listed in each table were combined in a cup using a centrifugal resin mixer (MAX 100 mixing cup and FlackTek Speedmixer DAC 150 FV; both from FlackTek Incorporated, Landrum, S.C.) and mixed at 3000 rpm for 1 minute.

### Example Articles Produced

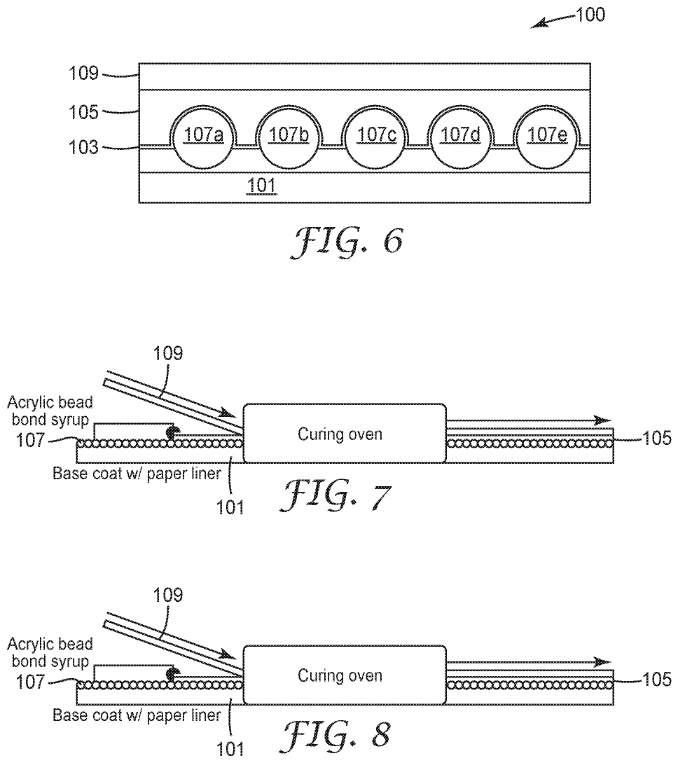

FIG. 6 shows a schematic depiction of the fabricated article used to analyze various properties of disclosed compositions. The article 100, as seen in FIG. 1 includes a liner 101, a vapor coat 103, a bead bond layer 105 with optical beads 107a-107e embedded therein, and an application layer 109. Disclosed compositions can be utilized in either the bead bond layer or the application layer.

FIG. 7 shows a schematic depiction of how articles of FIG. 6 were fabricated in below examples when adhesive compositions were being evaluated as the bead bond layer and the application layer was fabric.

FIG. 8 shows a schematic depiction of how articles of FIG. 6 were fabricated in below examples when adhesive compositions were being evaluated as the bead bond layer and the application layer was a second adhesive composition.

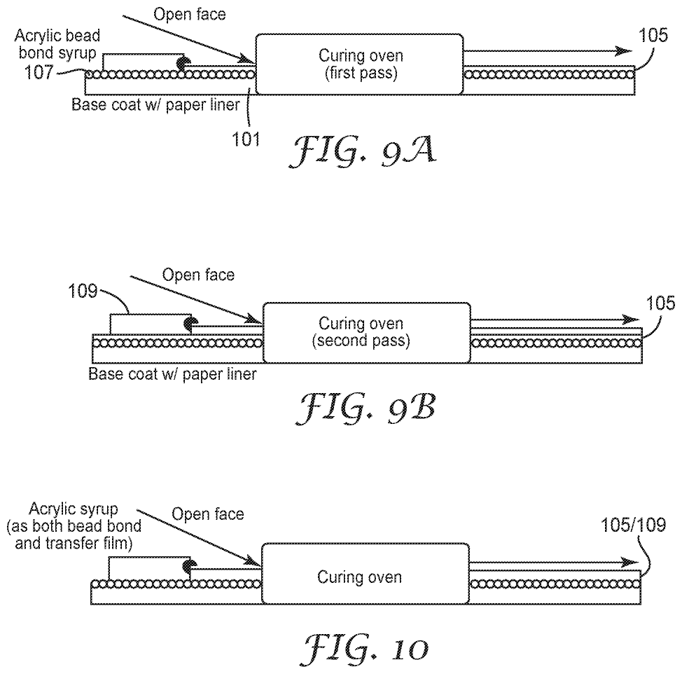

FIGS. 9a and 9b show a schematic depiction of how articles of FIG. 6 were fabricated in below examples when adhesive compositions were being evaluated both as the bead bond layer and the application layer using a two step curing process.

FIG. 10 shows a schematic depiction of how articles of FIG. 6 were fabricated in below examples when a single adhesive composition was being evaluated both as the bead bond layer and the application layer using a single step curing process.

### Example 1: Testing of Adhesive Properties

Retroreflective material commercially available under the trade designation “Scotchlite C420” (phenolic rubber bead bond product) was coated with the adhesive composition of Table 3 below using a notch bar coating station with a gap setting of 0.005 inches (125 micrometers). Then, the resulting open face combinations were exposed to a total UV-A energy of approximately 2400 milliJoules/square centimeter from the top in a nitrogen-inerted environment using a plurality of fluorescent lamps having a peak emission wavelength of 365 nanometers.

Four articles were laminated at either 280° F. (137.8° C.) for 325° F. (162.8° C.) with the four different adhesive compositions given below. Table 3 below indicates whether or not lamination occurred.

TABLE 3

| | | Polymer | Polymer | | |
|---|---|---|---|---|---|
| EHA | AA | Add Type | Add Loading | TMPTA | Irg 819 |
| 78 | 10 | PVB-B30H | 12 | 2 | 0.8 |
| 78 | 10 | PVB-B30HH | 12 | 2 | 0.8 |
| 78 | 10 | PVB-B60H | 12 | 2 | 0.8 |
| 78 | 10 | PVB-B60HH | 12 | 2 | 0.8 |

| | Able to adhere laminate | Able to laminate |
|---|---|---|
| | at 280° F. | at 325° F. |
| Sample | (137.8° C.) | (162.8° C.) |
| 30HH | Yes | Yes |
| 30H | No | No |
| 60HH | No | Yes |
| 60H | No | No |

### Example 2: A-Film as Bead Bond With Fabric as Backing

An article including a liner 101, a vapor coat 103 and a bead bond layer 105 with optical beads 107a-107e embedded therein as seen in FIG. 1 was coated with the adhesive composition of Table 3 below using a notch bar coating station with a gap setting of 0.005 inches (125 micrometers). Then, a fabric (application layer 109 in FIG. 6) (polyester/cotton) was laminated onto the top of the coated syrup and the resulting open face combinations were exposed to a total UV-A energy of approximately 3648 milliJoules/square centimeter from the top in a nitrogen-inerted environment using an plurality of fluorescent lamps having a peak emission wavelength of 365 nanometers as depicted in FIG. 7. The total UV-A energy was determined using a POWERMAP radiometer equipped with lower power sensing head (available from EIT Incorporated, Sterling, Va.). The radiometer web speed and energy were then used to calculate the total exposure energy at the web speed used during curing of the acrylic composition.

TABLE 4
Detailed formulation of adhesive composition in Example 2

| | | | | CN965 | | | Uniplex | PVB- |
|---|---|---|---|---|---|---|---|---|
| Component | EHA | IBOA | AA | (50% in IBOA) | HEA | Irg 819 | 400 | B30HH |
| Parts | 42.5 | 21.2 | 2.6 | 5.3 | 2.6 | 0.7 | 10.0 | 15.9 |

After curing, paper/PE carrier on bead side was removed, and the resulting structure was evaluated according to ASTM D1388 for drape (flexural rigidity). As shown in Table 5, the fabric sample with this adhesive composition was compared to “Scotchlite 8910” and “Scotchlite 8912” and showed similar drape to “Scotchlite 8912”.

TABLE 5
Ex. 2 Drape Results Compared to Reflective Materials “Scotchlite
8910” and “Scotchlite 8912”

| | Bending | 1″ × 8″ | | Flexural |
|---|---|---|---|---|
| | Length | Weight | Mass | Rigidity |
| Sample ID | (mm) | (grams) | (g/m2) | (mN-m) |
| Scotchlite 8910 | 27.5 | 1.59 | 308 | 0.063 |
| Scotchlite 8912 | 32.5 | 1.58 | 306 | 0.103 |
| Ex. 2 | 34.5 | 1.48 | 287 | 0.115 |

Example 2 was home washed according to ISO 6330 method 2A (Prog. 61). Table 6 shows wash results, Example 2 shows a similar reflectivity drop trend compared to “Scotchlite 8910”.

TABLE 6

| | Ra | Ra after | Ra after | Ra after | Ra after |
|---|---|---|---|---|---|
| Sample | initial | 5 cycles | 10 cycles | 15 cycles | 20 cycles |
| Scotchlite 8910 | 490 | 379 | 269 | 221 | 197 |
| Example 2 | 437 | 288 | 195 | 118 | 61 |

### Example 3: A-Film as Bead Bond With Polyester Hot Melt Adhesive as Backing

A composition (Table 7) was coated with a gap setting of 0.004 inches (100 micrometers) in between a vapor coat substrate (Scotchlite 8710) and 3 mil polyester hot melt adhesive using a notch bar coating station. The resulting combination was exposed to a total UV-A energy of approximately 1824 milliJoules/square centimeter from the top using a plurality of fluorescent lamps having a peak emission wavelength of 365 nanometers. The total UV-A energy was determined using a POWERMAP radiometer equipped with lower power sensing head (available from EIT Incorporated, Sterling, Va.). The radiometer web speed and energy were then used to calculate the total exposure energy at the web speed used during curing of the acrylic composition. A simplified schematic of the construction is show in FIG. 8. Example 3 has similar construction to “Scotchlite 8725” except “Scotchlite 8725” has phenolic rubber chemistry as bead bond.

TABLE 7
Adhesive Composition as bead bond in parts.

| | | | CN965 | | PVB- | Uniplex |
|---|---|---|---|---|---|---|
| EHA | IBOA | AA | (50% in IBOA) | Irg 819 | B30HH | 400 |
| 50.7 | 10.2 | 2.4 | 4.80 | 0.67 | 14.6 | 20.0 |

After curing, the paper/PE liner was removed from bead side and the drape (flexural rigidity) of sample with bead bond F5 was measured (Table 8). The substrate with 20% Uniplex 400 plasticizer has similar drape compared to “Scotchlite 8725”.

TABLE 8
Drape results of Example 3 and “Scotchlite 8725”.

| | Bending | 1″ × 8″ | | Flexural |
|---|---|---|---|---|
| | Length | Weight | Mass | Rigidity |
| Sample | (mm) | (grams) | (g/m2) | (mN-m) |
| Scotchlite 8725 | 21.5 | 1.26 | 244 | 0.024 |
| Ex. 3 | 21 | 1.7 | 329 | 0.03 |

Transfer films samples were laminated to fabric at 325F, 35 psi, 15 seconds, and then home washed using ISO 6330 method 2A. Table 9 below shows wash comparison between Example 3 and “Scotchlite 8725”. Transfer film products with Ex. 3 as bead bond showed good wash performance.

TABLE 9

| | Ra | Ra after | Ra after | Ra after | Ra after |
|---|---|---|---|---|---|
| Sample | initial | 5 cycles | 10 cycles | 15 cycles | 20 cycles |
| Scotchlite 8725 | 497 | 487 | 477 | 470 | 461 |
| Ex. 3 | 528 | 508 | 507 | 482 | 489 |

### Example 4: Adhesive Composition as Hot Melt Adhesive in SRM Products

Table 10 shows an adhesive composition that can be utilized in an application layer.

TABLE 10

| | EHA | AA | B30HH | DPA | 651 |
|---|---|---|---|---|---|
| Ex. 4 | 78 | 12 | 10 | 2 | 0.33 |

A 2.5 mil layer of Ex. 4 was laminated to “Scotchlite C420” (phenolic rubber bead bond product), and then the whole construction was hot laminated to fabric at 325F, 35 psi, 15 seconds. The sample was washed using ISO 6330 method 2A. Table 11 shows washed results, “Scotchlite C420” using Ex. 4 as adhesive has very similar wash performance compared to “Scotchlite C750” and has much better wash performance than “Scotchlite C725”.

TABLE 11

| | Ra | Ra after | Ra after | Ra after | Ra after | Ra after | Ra after | Ra after | Ra after | Ra after | Ra after |
|---|---|---|---|---|---|---|---|---|---|---|---|
| Sample | initial | 5 cycles | 10 cycles | 15 cycles | 20 cycles | 25 cycles | 30 cycles | 35 cycles | 40 cycles | 45 cycles | 50 cycles |
| Scotchlite C725 | 488 | 471 | 437 | 417 | 381 | 347 | 321 | 281 | 252 | 237 | 206 |
| Scotchlite C750 | 497 | 487 | 477 | 470 | 461 | 459 | 441 | 413 | 415 | 391 | 387 |
| Ex. 4 | 540 | 512 | 487 | 480 | 455 | 447 | 413 | 397 | 407 | 380 | 354 |

### Example 5: Adhesive Composition as Bead Bond and Hot Melt Adhesive Through Two Pass Coating

Samples using the same adhesive composition as both bead bond and hot melt adhesive were prepared in two passes. In the first pass, the “Scotchlite 8710” vapor coat was used as the bottom input liner, and the bead bond syrup (Table 12) was coated over the bead coat using a notch bar coating station with a gap setting of 0.002 inches (51 micrometers). The resulting open face combinations were exposed to a total UV-A energy of approximately 3648 milliJoules/square centimeter from the top in a nitrogen-inerted environment using an plurality of fluorescent lamps having a peak emission wavelength of 365 nanometers. Then, in the second pass, the cured combination from the first pass (vapor coat+bead bond) was used as the input liner, and the transfer film syrup (Table 13) was coated over the bead coat using a notch bar coating station with a gap setting of 0.004 inches (100 micrometers). The resulting open face combinations were exposed to a total UV-A energy of approximately 912 milliJoules/square centimeter from the top in a nitrogen-inerted environment using an plurality of fluorescent lamps having a peak emission wavelength of 365 nanometers. A simplified schematic of the construction is show in FIGS. 9a and 9b.

TABLE 12

| | | EHA | IBOA | AA | CN965 | PVB-B30HH | 819 | U400 |
|---|---|---|---|---|---|---|---|---|
| Example 5a | parts | 60.8 | 15.1 | 2.9 | 2.9 | 17.5 | 0.8 | 10 |

TABLE 13

| | | EHA | AA | DPA | PVB-B30HH | 651 |
|---|---|---|---|---|---|---|
| Example 5b | parts | 78.0 | 12.0 | 2.0 | 10.0 | 0.33 |

After curing, paper/PE liner was removed from bead side, and drape results in Table 14 shows above formulations as bead bond and hot melt adhesive results in slightly lower drape compared to “Scotchlite 8725” transfer film product.

TABLE 14

| | Bending | 1″ × 8″ | | Flexural |
|---|---|---|---|---|
| | Length | Weight | Mass | Rigidity |
| Sample ID | (mm) | (grams) | (g/m2) | (mN-m) |
| Scotchlite 8725 | 21.5 | 1.26 | 244 | 0.024 |
| Ex. 5a/5b | 18.5 | 1.56 | 302 | 0.019 |
| product | | | | |

Transfer film samples were laminated to a fabric at 280° F., 35 psi, 15 seconds, and then washed using ISO 6330 method 2A. Table 15 shows the sample after 25 cycles. The article made using Example 5a/5b showed good results

TABLE 15

| | Ra | Ra after | Ra after | Ra after | Ra after | Ra after |
|---|---|---|---|---|---|---|
| Sample | initial | 5 cycles | 10 cycles | 15 cycles | 20 cycles | 25 cycles |
| Scotchlite 8725 | 497 | 487 | 477 | 470 | 461 | 459 |
| Ex. 5a/5b | 535 | 511 | 508 | 477 | 426 | 401 |

### Example 6: Adhesive Composition as Bead Bond and Hot Melt Adhesive in a Single Pass Coating

“Scotchlite 8710” vapor coat was used as the bottom input liner, and the acrylic syrup (Table 16, Ex. 6a or 6b) was coated using a notch bar coating station with a gap setting of 0.005 inches (125 micrometers). The resulting open face combinations were exposed to a total UV-A energy of approximately 2400 milliJoules/square centimeter from the top in a nitrogen-inerted environment using a plurality of fluorescent lamps having a peak emission wavelength of 365 nanometers. A simplified schematic of the construction is show in FIG. 10.

TABLE 16

| Example | | 2 EHA | AA | DPA | PVB-B30HH | 651 |
|---|---|---|---|---|---|---|
| Ex. 6a | parts | 78.0 | 12.0 | 2.0 | 10.0 | 0.33 |
| Ex. 6b | parts | 78.0 | 10.0 | 2.0 | 12.0 | 0.33 |

After curing, the paper/PE bead carrier from the “Scotchlite 8710” vapor coat was removed, and the resulting structure was then evaluated according to ASTM D1388. Table 17 shows Drape results, both samples show better flexibility compared to “Scotchlite 8725”, and the sample with lower PVB amount (Ex. 6a) shows very low flexural rigidity.

TABLE 17
Drape results of samples using A-Film
as bead bond and adhesive, 1 pass.

| | Bending | 1″ × 8″ | | Flexural |
|---|---|---|---|---|
| | Length | Weight | Mass | Rigidity |
| Sample ID | (mm) | (grams) | (g/m2) | (mN-m) |
| Scotchlite 8725 | 21.5 | 1.26 | 244 | 0.024 |
| Ex. 6a | 15 | 1.21 | 234 | 0.008 |
| Ex. 6b | 19.5 | 1.22 | 236 | 0.017 |

Samples were laminated to fabric at 280F, 35 psi, 15 seconds, and then washed with ISO 6330 Method 2A. Table 18 shows good wash performance of samples that include an adhesive composition as bead bond and adhesive coated in one pass, where a single layer doubles both as the bead bond and the transfer film adhesive.

TABLE 18

| | Ra | Ra after | Ra after | Ra after | Ra after | Ra after |
|---|---|---|---|---|---|---|
| Sample | initial | 5 cycles | 10 cycles | 15 cycles | 20 cycles | 25 cycles |
| Scotchlite 8725 | 497 | 487 | 477 | 470 | 461 | 459 |
| Ex. 6a | 511 | 509 | 498 | 479 | 474 | 451 |
| Ex. 6b | 505 | 496 | 489 | 478 | 466 | 448 |

### Example 7: Adhesive Composition as Bead Bond With Fabric as Backing Using Intermediate Curing

TABLE 19

| Example | | 2 EHA | AA | DPA | PVB-B30HH | 819 |
|---|---|---|---|---|---|---|
| Ex. 7 | parts | 78.0 | 10.0 | 2.0 | 12.0 | 0.8 |

“Scotchlite 8710” vapor coat was used as the bottom input liner, and the acrylic syrup (Ex. 7, Table 19) was coated using a notch bar coating station with a gap setting of 0.005 inches (125 micrometers). The coated composition was exposed to a total UV-A energy as indicated in Table 20 on the open surface of the composition in a nitrogen-inerted environment using an array of LEDs having a peak emission wavelength of 405 nm. Following LED irradiation, the fabric (polyester/cotton) was laminated onto the top of the coated and irradiated syrup, and the resulting open face combinations were exposed to a total UV-A energy of approximately 2400 milliJoules/square centimeter from the top in a nitrogen-inerted environment using a plurality of fluorescent lamps having a peak emission wavelength of 365 nanometers.

After crosslinking, the paper/PE bead carrier from the “Scotchlite 8710” vapor coat was removed, and the resulting structure was then evaluated for drape (flexural rigidity) and retroreflectivity (Ra) (summarized in Table 20). The sample without any UV curing before fabric lamination show dirty stripping resulting in lower Ra, while all other three sample show clean stripping. Meanwhile, sample with higher LED dosage before fabric lamination (262 and 385 mJ/cm²) result in better flexibility.

TABLE 20

| | | Flexural | |
|---|---|---|---|
| | LED Dosage | Rigidity | |
| Example | (mJ/cm²) | (mN · m) | Ra |
| Ex. 7a | 262 | 0.046 | 525 |
| Ex. 7b | 385 | 0.049 | 532 |
| Ex. 7c | 120 | 0.126 | 539 |
| Ex. 7d | 0 | 0.068 | 431 |

### Example 8: Adhesive Composition as Bead Bond and Hot Melt Adhesive Using Electron Beam Crosslinking

TABLE 21

| Example | | EHA | AA | PVB-B30HH | 651 |
|---|---|---|---|---|---|
| Ex. 8 | parts | 78.0 | 10 | 12.0 | 0.33 |

“Scotchlite 8710” vapor coat was used as the bottom input liner, and the acrylic syrup (Ex. 8, Table 21) was coated using a notch bar coating station with a gap setting of 0.005 inches (125 micrometers). The resulting open face combinations were exposed to a total UV-A energy of approximately 2400 milliJoules/square centimeter from the top in a nitrogen-inerted environment using a plurality of fluorescent lamps having a peak emission wavelength of 365 nanometers.

After curing, the open face combination was crosslinked by exposing it to an electron beam (CB-300 Energy Sciences, Inc., Wilmington Mass.) with an intensity of 240 kV at a dosage of 0, 4, 8, 12, or 20 Mrad (see Table 22) or 8 Mrad (Ex. 8c), at a web speed of 10 feet/minute.

After crosslinking, the paper/PE bead carrier from the “Scotchlite 8710” vapor coat was removed, and the resulting structure was then evaluated for drape (flexural rigidity) and retroreflectivity (Ra) (summarized in Table 22). Example 8e showed dirty stripping (beads left on carrier) and Ra is lower than other samples. Example 8c with 8 Mrad dosage showed an increased drape (as expected due to increased crosslink density), clean stripping, and good Ra.

TABLE 22

| | | Flexural | |
|---|---|---|---|
| | Dosage | Rigidity | |
| Sample ID | (Mrad) | (mN · m) | Ra |
| Ex. 8a | 0 | 0.013 | 542 |
| Ex. 8b | 4 | 0.012 | 540 |
| Ex. 8c | 8 | 0.016 | 540 |
| Ex. 8d | 12 | 0.011 | 536 |
| Ex. 8e | 20 | 0.009 | 507 |

### Example 9: Different PVB Molecular Weight

TABLE 23

| | | | | CN965 | | | PVB |
|---|---|---|---|---|---|---|---|
| | EHA | IBOA | AA | (50% in IBOA) | HEA | Irg 819 | B60H |
| Ex. 9a | 27.39% | 12.50% | 11.41% | 15.94% | 11.41% | 1.00% | 19.25% |
| Ex. 9b | 30.68% | 14.00% | 12.78% | 17.85% | 12.78% | 1.12% | 10.00% |

PVB (Polyvinyl butyral) of different molecular weights were purchased from Kuraray under the trade designation “Mowital”. Varying grades with different molecular weights and degrees of acetalization are available (see http://www.kuraray.us.com/wp-content/uploads/2012/12/TDS-Mowital_EN.pdf). PVB B6OH has 18-21% polyvinyl alcohol content at a molecular weight of approximately 60,000, while PVB 30HH has 11-14% polyvinyl alcohol content at a molecular weight of approximately 30,000.

The coating procedure was the same as example 2 with the fabric of the “Scotchlite 8910” vapor coat being used as the bottom input liner, and the acrylic syrup (Table 23) was coated using a notch bar coating station with a gap setting of 0.005 inches (125 micrometers). Then, the fabric (polyester/cotton) was laminated onto the top of the coated syrup and the resulting open face combinations were exposed to a total UV-A energy of approximately 3648 milliJoules/square centimeter from the top in a nitrogen-inerted environment using a plurality of fluorescent lamps having a peak emission wavelength of 365 nanometers. The total UVA energy was determined using a POWERMAP radiometer equipped with lower power sensing head (available from EIT Incorporated, Sterling, Va.). The radiometer web speed and energy were then used to calculate the total exposure energy at the web speed used during curing of the acrylic composition.

After curing, paper/PE carrier on bead side was removed, and samples were home washed per ISO 6330 method 2A, wash results are summarized in Table 24.

TABLE 24

| | Ra | Ra after | Ra after |
|---|---|---|---|
| Sample | initial | 5 cycles | 10 cycles |
| Ex. 9a | 521 | 271 | 112 |
| Ex. 9b | 523 | 210 | 35 |

### Example 10: Amount of PVB

Bead bond formulations with PVB loading from 0 to 25% (Table 25) syrup was coated with a gap setting of 0.002 inches (50 micrometers) in between a vapor coat substrate (“Scotchlite 8710” production vapor coat) and 3 mil polyester hot melt adhesive using a notch bar coating station. The resulting combination was exposed to a total UV-A energy of approximately 2400 milliJoules/square centimeter from the top using a plurality of fluorescent lamps having a peak emission wavelength of 365 nanometers. The total UV-A energy was determined using a POWERMAP radiometer equipped with lower power sensing head (available from EIT Incorporated, Sterling, Va.). The radiometer web speed and energy were then used to calculate the total exposure energy at the web speed used during curing of the acrylic composition.

TABLE 25
loading in parts

| | | | | CN965 | Irg | PVB- |
|---|---|---|---|---|---|---|
| | EHA | IBOA | AA | (50% in IBOA) | 819 | B30HH |
| Ex. 10a | 75 | 15.5 | 2.9 | 5.8 | 0.8 | 0 |
| Ex. 10b | 71 | 14.5 | 2.9 | 5.8 | 0.8 | 5 |
| Ex. 10c | 62.5 | 13 | 2.9 | 5.8 | 0.8 | 15 |
| Ex. 10d | 54.5 | 11 | 2.9 | 5.8 | 0.8 | 25 |

| | | | | TMPTA | Irg | PVB- |
|---|---|---|---|---|---|---|
| | EHA | IBOA | AA | stock | 819 | B30HH |
| Ex. 10e | 60.3 | 12.5 | 2.9 | 0.2 | 0.8 | 25 |

After curing, the transfer film samples were laminated to fabric at 325F, 40 psi, 20 seconds. Table 26 below show retroreflectivity of the samples.

TABLE 26

| Sample | Ra |
|---|---|
| Ex. 10a | 494 |
| Ex. 10b | 502 |
| Ex. 10c | 508 |
| Ex. 10d | 503 |
| Ex. 10e | 504 |

### Example 11: Amount of Polar Monomer

Compositions as seen in Table 27 were made.

TABLE 27
loading in parts

| | | | | CN965 | | | PVB |
|---|---|---|---|---|---|---|---|
| | EHA | IBOA | AA | (50% in IBOA) | HEA | Irg 819 | B30HH |
| Ex. 11a | 46.7 | 23.3 | 2.9 | 5.8 | 2.9 | 0.8 | 17.5 |
| Ex. 11b | 48.6 | 24.3 | 1.5 | 5.8 | 1.5 | 0.8 | 17.5 |
| Ex. 11c | 50.6 | 25.3 | 0.0 | 5.8 | 0.0 | 0.8 | 17.5 |

The coating procedure same as Example 2 above with “Scotchlite 8910” vapor coat being used as the bottom input liner, and the acrylic syrup (Table 27) was coated using a notch bar coating station with a gap setting of 0.005 inches (125 micrometers). Then, the fabric (polyester/cotton) was laminated onto the top of the coated syrup and the resulting open face combinations were exposed to a total UV-A energy of approximately 3648 milliJoules/square centimeter from the top in a nitrogen-inerted environment using an plurality of fluorescent lamps having a peak emission wavelength of 365 nanometers. The total UVA energy was determined using a POWERMAP radiometer equipped with lower power sensing head (available from EIT Incorporated, Sterling, Va.). The radiometer web speed and energy were then used to calculate the total exposure energy at the web speed used during curing of the acrylic composition.

After curing, paper/PE carrier on bead side was removed, and samples were home washed per ISO 6330 method 2A, wash results are summarized in Table 28. The sample with 0% AA show worst wash performance.

TABLE 28

| | Ra | Ra after | Ra after |
|---|---|---|---|
| Sample | initial | 5 cycles | 10 cycles |
| Ex. 11a | 498 | 496 | 279 |
| Ex. 11b | 496 | 302 | 212 |
| Ex. 11c | 497 | 49 | 0 |

Thus, embodiments of adhesive compositions including polyvinyl acetal resins are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

1. An adhesive composition comprising:
polymerized units of one or more (meth)acrylate ester monomers derived from an alcohol containing 1 to 14 carbon atoms;
polyvinyl acetal resin; and
at least one initiator.

2. The adhesive composition according to claim 1, wherein the alcohol containing 1 to 14 carbon atoms is selected from: esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol; 3,5,5 -trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, or combinations thereof.

3. The adhesive composition according to claim 1, wherein the polymerized units of one or more (meth) acrylate ester monomers are selected from: ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, 2-octyl acrylate, isooctyl acrylate, isononyl acrylate, decyl acrylate, isodecyl acrylate, lauryl acrylate, isotridecyl acrylate, octadecyl acrylate, dodecyl acrylate, and combinations thereof.

4. The adhesive composition according to claim 1, wherein the polymerized units of one or more (meth) acrylate ester monomers are selected from: 2-ethylhexyl (meth)acrylate, isooctyl (meth)acrylate, n-octyl (meth)acrylate, 2-octyl (meth)acrylate, isodecyl (meth)acrylate, and lauryl (meth)acrylate and combinations thereof.

5. The adhesive composition according to claim 1, wherein at least some of the polymerized units of one or more (meth)acrylate ester monomers derived from an alcohol containing 1 to 14 carbon atoms comprise monomers when reacted to form a homopolymer has a Tg no greater than 0° C.

6. The adhesive composition according to claim 5, wherein the monomer when reacted to form a homopolymer has a Tg no greater than 0° C. has the formula:
H₂C═CR¹C(O)OR⁸
wherein R¹ is H or methyl and R⁸ is an alkyl with 1 to 22 carbons or a heteroalkyl with 2 to 20 carbons and 1 to 6 heteroatoms selected from oxygen or sulfur.

7. The adhesive composition according to claim 5, wherein the monomer when reacted to form a homopolymer has a Tg no greater than 0° C. is selected from: ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, 2-octyl acrylate, isooctyl acrylate, isononyl acrylate, decyl acrylate, isodecyl acrylate, lauryl acrylate, isotridecyl acrylate, octadecyl acrylate, dodecyl acrylate, and combinations thereof.

8. The adhesive composition according to claim 5, wherein the monomer when reacted to form a homopolymer has a Tg no greater than 0° C. is selected from: 2-ethylhexyl (meth)acrylate, isooctyl (meth)acrylate, n-octyl (meth)acrylate, 2-octyl (meth)acrylate, isodecyl (meth)acrylate, lauryl (meth)acrylate, and combinations thereof.

9. The adhesive composition according to claim 1, wherein at least some of the polymerized units of one or more (meth)acrylate ester monomers derived from an alcohol containing 1 to 14 carbon atoms comprise monomers when reacted to form a homopolymer has a Tg greater than 0° C.

10. The adhesive composition according to claim 9, wherein the monomer when reacted to form a homopolymer has a Tg greater than 0° C. is selected from: t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, norbornyl (meth)acrylate, benzyl methacrylate, 3,3,5 trimethylcyclohexyl acrylate, cyclohexyl acrylate, N-octyl acrylamide, and propyl methacrylate and combinations thereof.

11. The adhesive composition according to claim 1, wherein the polyvinyl acetal resin comprises polymerized units having the formula: 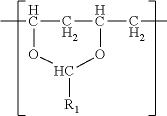
wherein R₁ is hydrogen or a C1-C7 alkyl group.

12. The adhesive composition according to claim 1, wherein the composition comprises 0.1 to 25 wt-% of polyvinyl acetal resin based on the total weight of the composition, 10 to 25 wt-% of polyvinyl acetal resin based on the total weight of the composition, or 15 to 20 wt-% of polyvinyl acetal resin based on the total weight of the composition.

13. The adhesive composition according to claim 1, wherein the polyvinyl acetal resin has an average molecular weight of 10,000 to 100,000 g/mole, or 30,000 to 60,000 g/mole.

14. The adhesive composition according to claim 1, wherein the initiator is a photoinitiator.

15. The adhesive composition according to claim 1, wherein the initiator is a thermal initiator.

16. The adhesive composition according to claim 1 further comprising a polar functional monomer.

17. The adhesive composition according to claim 15, wherein the polar functional monomer comprises acrylic acid.

18. The adhesive composition according to claim 16, wherein the adhesive composition comprises 1 to 15 wt-% polar functional monomer, 1.5 to 12 wt-% polar functional monomer, or 2 to 10 wt-% polar functional monomer based on the total weight of the adhesive composition.

19. The adhesive composition according to claim 1 further comprising one or more silane coupling agents.

20. (canceled)

21. An article comprising:
at least one application layer;
at least one bead bond layer;
a layer of optical elements that are partially embedded in the at least one bead bond layer; and
at least one reflective layer that is located functionally between the layer of optical elements and the bead bond layer,
wherein the at least one bead bond layer, the at least one application layer, or both comprise a cured product of an adhesive composition according to any of claims 1 to 20.

22.-42. (canceled)
